(19) United States
(12) Patent Application Publication
(10) Pub. No.: US 2013/0220915 A1
(43) Pub. Date: Aug. 29, 2013

(54) SEPARATION MEMBRANE ELEMENT AND FLUID COLLECTING TUBE FOR SEPARATION MEMBRANE ELEMENT

(71) Applicants: Shinichi Chikura, Ibaraki-shi (JP); Toshimitsu Hamada, Ibaraki-shi (JP)

(72) Inventors: Shinichi Chikura, Ibaraki-shi (JP); Toshimitsu Hamada, Ibaraki-shi (JP)

(73) Assignee: NITTO DENKO CORPORATION, Ibaraki-shi, Osaka (JP)

(21) Appl. No.: 13/876,611

(22) PCT Filed: Sep. 27, 2011
(86) PCT No.: PCT/JP2011/072064

§ 371 Date: May 15, 2013

(30) Foreign Application Priority Data
Sep. 30, 2010 (JP) 2010-221891

(51) Int. Cl. B01D 63/10; B01D 63/00

(52) U.S. Cl. CPC B01D 63/10; B01D 63/00
USPC 210/457; 210/541

(57) ABSTRACT

Provided is a separation membrane element used under a high-temperature environment, in which the stress acting on a portion for fixing between a fluid collecting tube and a separation membrane is reduced and a deformation caused by receiving a long time thermal history can be prevented, and also provided is a fluid collecting tube used for the separation membrane element. The separation membrane element has a fluid collecting tube (10), a separation membrane, and fixing portions (4) provided at at least two places and fixing between the fluid collecting tube (10) and the separation membrane. The separation membrane element has at least one elastic portion in the fluid collecting tube (10) between the fixing portions (4).

### TECHNICAL FIELD

The present invention relates to a separation membrane element using a fluid collecting tube for the separation membrane element that allows a fluid supplied to a separation membrane or a fluid permeated from a separation membrane to pass therethrough.

### BACKGROUND ART

In order to separate components of a fluid, various separation membrane elements of tube-shaped type, hollow thread type, spiral type, pleated type, and the like are used. For example, Patent Document 1 described below discloses a spiral-type separation membrane element having a wound body in which a single one of or a plurality of a separation membrane, a feed side flow path material, and a permeate side flow path material are wound around a perforated water-collecting tube.

In using a separation membrane element such as described above, filtration with the separation membrane is carried out by loading a pressure container with the separation membrane element, allowing a processing liquid to flow into the aforesaid pressure container, and pressurizing the processing liquid. Here, depending on the purpose of processing or usage, the separation membrane element may be exposed to high-temperature conditions such as high-temperature hot water or water vapor. For example, in a spiral-type separation membrane element used for processing in the field of foods, pharmaceuticals, and fine chemicals, or in waste liquid processing after these processes, an alkaline solution having a high liquid temperature may be supplied as the processing liquid.

Also, a separation membrane module using the pervaporation (PV) method or a separation membrane module using the vapor permeation (VP) method such as disclosed in Patent Document 2 described below has a structure in which a high-temperature vapor generated by the separation membrane flows through a permeated gas spacer towards a gas collecting tube and is taken out from a gas collecting tube outlet. In this manner, depending on the purpose of processing or usage, there are cases in which a high-temperature fluid is processed in the separation membrane module.

### PRIOR ART DOCUMENTS

### Patent Documents

Patent Document 1: JP-A-2000-354742

Patent Document 2: JP-A-4-187220

### SUMMARY OF THE INVENTION

### Problems to be Solved by the Invention

The separation membrane element used in a high-temperature environment such as described above repeats being extended and contracted due to expansion at the time of high temperature and restoration (contraction) at the time of cooling. Hereafter, the problems generated in a high-temperature environment will be described by raising a spiral-type separation membrane element as an example.

Referring to FIG. 4A, the spiral-type separation membrane element has a structure in which a wound body 2 including a separation membrane and others is wound around a fluid collecting tube 1, and this wound body 2 is covered with an outer-cladding material 3. Also, in the wound body 2, two end portions 2a, 2b in the axial direction of the fluid collecting tube 1 are bonded to the fluid collecting tube 1 at fixing portions 4.

When a spiral-type separation membrane element such as described above is operated in a high-temperature environment, especially in a case in which the wound body 2 and the outer-cladding material 3 are different in material from the fluid collecting tube 1, a stress is applied to the fixing portions 4 by expansion of the wound body 2 or the outer-cladding material 3, as shown in FIG. 4B. Also, when the operation in a high-temperature environment is stopped, a stress is also applied to the fixing portions 4 by contraction of the wound body 2 or the outer-cladding material 3 due to cooling, as shown in FIG. 4C.

Thus, in the separation membrane element used in a high-temperature environment, a stress is applied to the fixing portions between the fluid collecting tube such as a water collecting tube or a gas collecting tube and the separation membrane due to extension and contraction of the separation membrane or the outer-cladding material, thereby raising a possibility such that the element may be destroyed by deformation of the element end portions E near the fixing portions (See FIGS. 4B and 4C), or the fluid collecting tube and the separation membrane may be exfoliated from each other at the fixing portions. Also, deformation may occur when the aforementioned fixing portions are heated (receive a thermal history) for a long period of time.

The present invention provides a separation membrane element that can reduce the stress applied to the fixing portions between the fluid collecting tube and the separation membrane and can prevent deformation due to receiving a thermal history for a long period of time in the separation membrane element used in a high-temperature environment, as well as a fluid collecting tube for a separation membrane element used therein.

### Means for Solving the Problems

The separation membrane element of the present invention is a separation membrane element including a fluid collecting tube, a separation membrane, and fixing portions provided at at least two places and fixing between the fluid collecting tube and the separation membrane, wherein the separation membrane element has at least one stretchable portion in the fluid collecting tube between the fixing portions.

In the separation membrane element of the present invention, the fluid collecting tube between the fixing portions has a stretchable portion. Therefore, even when the separation membrane or the outer-cladding material is extended or contracted in a high-temperature environment, the fluid collecting tube can follow this extension and contraction. By this, the whole element can be extended or contracted uniformly, whereby the stress applied to the fixing portions between the fluid collecting tube and the separation membrane can be reduced, and deformation due to receiving a thermal history for a long period of time can be prevented. Therefore, the separation membrane element can be used for a long period of time even in a high-temperature environment.

The stretchable portion may be an engagement structure or may be a movable portion that connects the fluid collecting tube main bodies with each other.

Also, the separation membrane element of the present invention may be a spiral-type separation membrane element in which a single one of or a plurality of the separation membrane, a feed side flow path material, and a permeate side flow path material are wound around the fluid collecting tube. In the spiral-type separation membrane element, the separation membrane and others are stacked around the fluid collecting tube, so that the extension/contraction stress due to the separation membrane and others tends to be large as compared with separation membrane elements other than the spiral type. Therefore, by applying the present invention to the spiral-type separation membrane element, the effect of the present invention can be effectively utilized.

The fluid collecting tube for a separation membrane element of the present invention is a fluid collecting tube for a separation membrane element having a stretchable portion that is extendible and contractible in an axial direction in a part of the fluid collecting tube.

The fluid collecting tube for a separation membrane element of the present invention has a stretchable portion that is extendible and contractible in the axial direction. Therefore, even when the separation membrane or the outer-cladding material is extended or contracted in a high-temperature environment, the fluid collecting tube can follow this extension and contraction. By this, the whole element can be extended or contracted uniformly, whereby the stress applied to the fixing portions between the fluid collecting tube and the separation membrane can be reduced, and deformation due to receiving a thermal history for a long period of time can be prevented. Therefore, the separation membrane element can be used for a long period of time even in a high-temperature environment.

### BRIEF DESCRIPTION OF THE DRAWINGS

FIG. 1 is a plan view illustrating one example of a fluid collecting tube for a separation membrane element of the present invention.

FIGS. 2A to 2I are each a schematic cross-sectional view illustrating one example of a stretchable portion used in the fluid collecting tube for a separation membrane element of the present invention.

FIGS. 3A to 3C are each a schematic cross-sectional view illustrating one example of a separation membrane element of the present invention.

FIGS. 4A to 4C are each a schematic cross-sectional view of a conventional spiral-type separation membrane element.

### DESCRIPTION OF REFERENCE SIGNS

1 fluid collecting tube
2 wound body
2a, 2b end portion of wound body
3 outer-cladding material
4 fixing portion
10 fluid collecting tube
10a stretchable portion
100 tube joint
101, 102 fluid collecting tube main body
103 bellows portion
103a inside apex portion of bellows portion
103b outside apex portion of bellows portion
104 stretchable member

### MODE FOR CARRYING OUT THE INVENTION

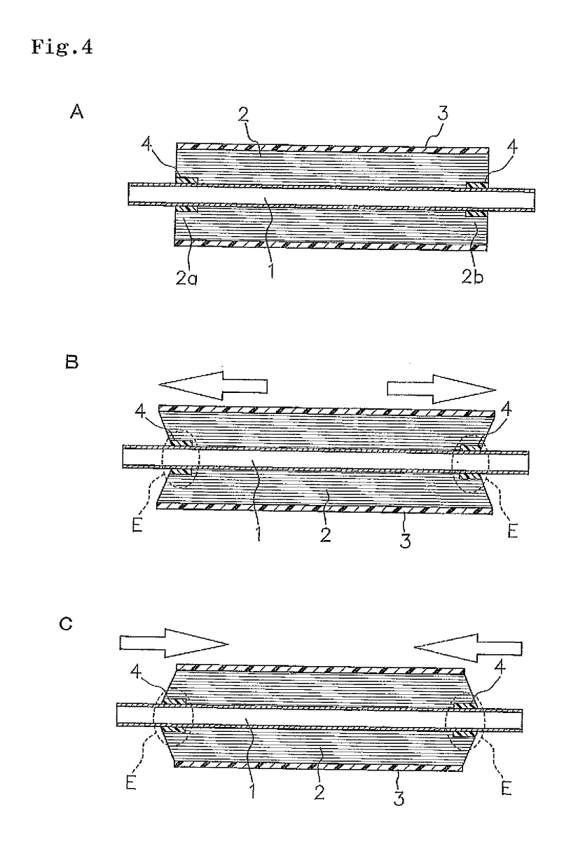

Hereafter, embodiments of the present invention will be described with reference to the attached drawings. Here, in the drawings made reference to, the same constituent elements as appear in the above-described FIGS. 4A to 4C will be denoted with the same reference signs, and the description thereof will be omitted.

The fluid collecting tube for a separation membrane element of the present invention may be a water collecting tube used in separating liquid components such as used for waste water processing or sea water desalination, or may be a gas collecting tube used in separating bio-ethanol or the like as gaseous components.

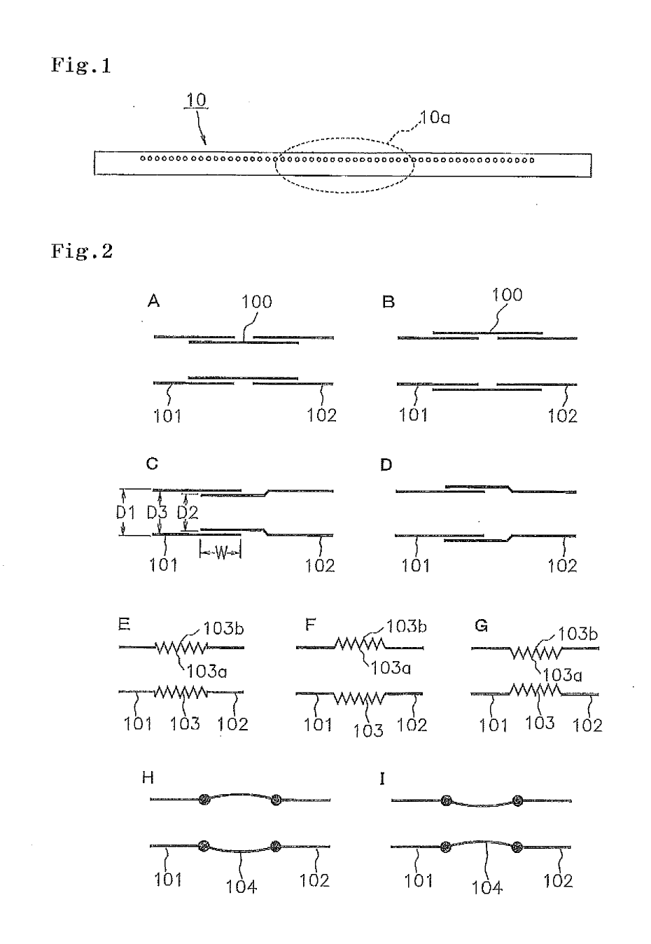

FIG. 1 is a plan view illustrating one example of a fluid collecting tube for a separation membrane element of the present invention. The fluid collecting tube 10 shown in FIG. 1 has a hollow structure having open holes provided around the tube and has at least one stretchable portion 10a that can be extended and contracted in an axial direction. For example, when resin is used in the separation membrane or in the outer-cladding material, the fluid collecting tube 10 undergoes extension of about 5 to 20 mm per 1 m by a temperature rise of about 100° C. For this reason, the stretchable portion 10a preferably has a structure that can ensure a width of movability of about 20 to 50 mm. Hereafter, a case will be described in which the fluid collecting tube 10 has a stretchable portion 10a at the central part in the axial direction.

As the stretchable portion 10a of the fluid collecting tube 10, those having a cross-sectional structure such as shown in FIGS. 2A to 2I can be used, for example. Among these, FIGS. 2A to 2D show a case in which the stretchable portion 10a is an engagement structure. Specifically, FIGS. 2A and 2B show a case in which the engagement is implemented by using a tube joint 100 provided as a body separated from the fluid collecting tube main bodies 101, 102. Also, FIGS. 2C and 2D show a case in which the engagement is implemented by providing a structure in which the fluid collecting tube main bodies 101, 102 can be engaged with each other. These can be constructed with a metal or resin which is a material of a conventionally used fluid collecting tube. Hereafter, each of the structures will be described in more detail.

FIGS. 2A to 2D show an example in which the distance between the two fluid collecting tube main bodies 101, 102 is made changeable by a stretchable portion 10a having an engagement structure. Among these, FIG. 2A shows a case in which the distance between the two fluid collecting tube main bodies 101, 102 is made changeable by a tube joint 100 having a smaller diameter than the two fluid collecting tube main bodies 101, 102. Also, FIG. 2B shows a case in which the distance between the two fluid collecting tube main bodies 101, 102 is made changeable by a tube joint 100 having a larger diameter than the two fluid collecting tube main bodies 101, 102. Also, FIG. 2C shows an example having a structure in which a fluid collecting tube main body 101 and a fluid collecting tube main body 102 having a part with a smaller diameter than the fluid collecting tube main body 101 are combined so that the fluid collecting tube main bodies 101 and 102 are engaged with each other. Also, FIG. 2D shows an example having a structure in which a fluid collecting tube main body 101 and a fluid collecting tube main body 102 having a part with a larger diameter than the fluid collecting tube main body 101 are combined so that the fluid collecting tube main bodies 101 and 102 are engaged with each other.

When an engagement structure such as described above is adopted as the stretchable portion 10a, the separation membrane element can be manufactured without making a great change from a method of manufacturing a conventional separation membrane element, thereby providing an advantage in terms of costs.

Regarding the dimension and the like of the tube of the engagement structure, in the case of constructing the engagement structure shown in FIG. 2C by using, for example, a metal tube made of stainless steel, titanium, or the like, the outer diameter D1 of the fluid collecting tube main bodies 101, 102 is about 10 to 80 mm, preferably 25 to 50 mm. At this time, the thickness of the fluid collecting tube main bodies 101, 102 is about 1 to 3.5 mm, so that the outer diameter D2 of the part of the fluid collecting tube main body 102 having a smaller diameter is preferably designed to be smaller by about 0.1 to 1 mm than the inner diameter D3 of the fluid collecting tube main body 101. In this case, a suitable design may be made in accordance with a fluid that is allowed to pass. However, when application is made to a gas collecting tube through which vapor is allowed to pass, the outer diameter D2 of the part of the fluid collecting tube main body 102 having a smaller diameter is preferably set to be smaller by about 0.1 to 0.5 mm than the inner diameter D3 of the fluid collecting tube main body 101. Also, the width W of the engagement part (overlapped part) at this time is about 40 to 50 mm. In a case in which the engagement structure shown in FIG. 2C is constructed by using a plastic tube made of polysulfone (PSF) resin or polyphenylene sulfide (PPS) resin, a dimension of the same degree as that of the above-described metal tube may be used. However, because the thickness of the tube must be set to be larger by 0.5 to 1 mm than that of the metal tube, a design must be made in accordance therewith.

Next, structures shown in FIGS. 2E to 2I will be described. FIGS. 2E to 2I show a case in which the stretchable portion 10a is a movable portion that connects the fluid collecting tube main bodies 101, 102 with each other. Specifically, FIGS. 2E to 2G show a case having a bellows structure. Also, FIGS. 2H and 2I show a structure in which a stretchable material is used as the stretchable portion 10a, and the fluid collecting tube main bodies 101, 102 are connected with each other by this stretchable portion 10a. A material that can be used in these movable portions is not particularly limited as long as the material can meet the extension/contraction ratio generated by the material of the separation membrane and others and the thermal history applied to the separation membrane. However, those in which a metal such as thin stainless steel, titanium, or hastelloy is molded into a bellows structure, or methods using fluororesin, fluororubber, silicone rubber, or the like can be raised as examples. Hereafter, each of the structures will be described in more detail.

FIGS. 2E to 2G show an example in which the stretchable portion 10a is a movable portion that connects the two fluid collecting tube main bodies 101, 102 with each other and is formed of a bellows portion 103. Among these, FIG. 2E shows an example in which, at the time of use other than in a high-temperature environment, the diameter of the bellows portion 103 at an inside apex portion 103a is smaller than the diameter of the two fluid collecting tube main bodies 101, 102, and the diameter of the bellows portion 103 at an outside apex portion 103b is larger than the diameter of the two fluid collecting tube main bodies 101, 102. Also, FIG. 2F shows an example in which, at the time of use other than in a high-temperature environment, the diameter of the bellows portion 103 at an inside apex portion 103a has a size approximately equal to the diameter of the two fluid collecting tube main bodies 101, 102. Also, FIG. 2G shows an example in which, at the time of use other than in a high-temperature environment, the diameter of the bellows portion 103 at an outside apex portion 103b has a size approximately equal to the diameter of the two fluid collecting tube main bodies 101, 102. As a material constituting the bellows portion 103, for example, a thin metal material made of a metal such as stainless steel, titanium, or hastelloy and having a thickness of about 0.1 to 0.8 mm, a rubber material such as fluororubber or silicone rubber, or a resin material such as fluororesin can be raised as an example.

By allowing the stretchable portion 10a to have a structure shown in FIGS. 2E to 2G, the property of following the extension and contraction in the axial direction is enhanced as compared with other structures, so that it is suitable when a temperature change is large or when it is used in a separation membrane element having a high extension/contraction ratio.

FIGS. 2H and 2I show an example in which the stretchable portion 10a is formed of a stretchable member 104 that connects the two fluid collecting tube main bodies 101, 102. Among these, FIG. 2H shows an example in which a stretchable member 104 that expands to the outside of the tube at the time of contraction is used. Also, FIG. 2I shows an example in which a stretchable member 104 that expands to the inside of the tube at the time of contraction is used. As a material constituting the stretchable member 104, for example, a rubber material such as silicone rubber, fluororubber, acrylic rubber, ethylene propylene rubber, butyl rubber, or hydrogenated nitrile rubber, or a resin material such as fluororesin or PET resin can be raised as an example. Typically, however, a rubber material is preferably used.

By allowing the stretchable portion 10a to have a structure shown in FIGS. 2H and 2I, the influence of step difference at the time of winding the separation membrane can be minimized, and also unnecessary space is hardly generated due to structural reasons as compared with other methods, so that the separation efficiency of the element can be enhanced more easily.

In the present invention, as a constituent material of the fluid collecting tube 10 other than the stretchable portion 10a, a constituent material of a conventionally known fluid collecting tube can be used. For example, a resin material such as acrylonitrile•butadiene•styrene copolymer resin (ABS resin), polyphenyleneether resin (PPE resin), or polysulfone resin (PSF resin), a metal material such as stainless steel or titanium, or the like can be used. In particular, when it is operated at a high temperature, those made of a metal material are preferably used.

The inner diameter of the fluid collecting tube 10 may differ in accordance with the size of the separation membrane element that is put to use; however, the inner diameter is, for example, 20 to 100 mm. The thickness of the fluid collecting tube 10 may differ in accordance with the purpose of processing or usage; however, the thickness is, for example, 1 to 7 mm.

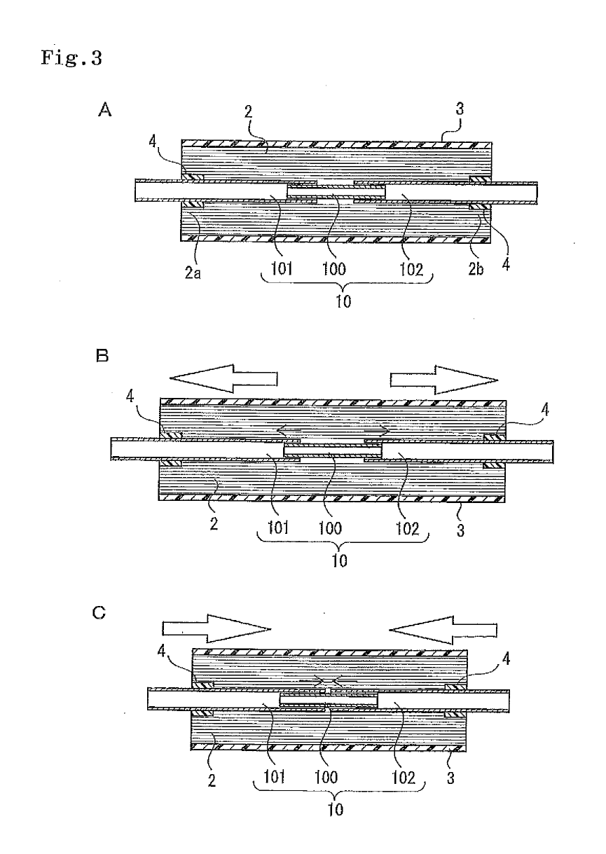

Next, the separation membrane element of the present invention will be described by raising, as an example, a spiral-type separation membrane element using a fluid collecting tube 10 having a structure shown in FIG. 2A. FIGS. 3A to 3C are schematic cross-sectional views illustrating the spiral-type separation membrane element.

The spiral-type separation membrane element shown in FIG. 3A has a structure such that a single one of or a plurality of a separation membrane, a feed side flow path material, and a permeate side flow path material are wound around a fluid collecting tube 10. The construction of the aforesaid spiral-type separation membrane element other than the fluid collecting tube 10 is described in detail also in Patent Document 1 described above, for example, and any of a separation membrane, a feed side flow path material, and a permeate side flow path material that are conventionally known in the art can be adopted. For example, when a plurality of a separation membrane, a feed side flow path material, and a permeate side flow path material are used, it will be a structure having a wound body 2 in which a plurality of membrane leaves are wound around a central tube. Here, in a separation membrane element of high heat-resistance type used in the PV method or the VP method, a flat membrane made of a conventionally known material such as polyphenylene sulfide (PPS), polyvinylidene fluoride (PVDF), or polydimethylsiloxane (PDMS), or a composite membrane of these, for example, can be used as the separation membrane. As a flow path material, a net made of resin such as PPS or ethylene-chlorotrifluoroethylene copolymer (ECTFE), or the like can be used.

Also, in the separation membrane element of the present invention, it is preferable to use an outer-cladding material 3 (See FIG. 3A) and an end member (not illustrated in the drawings) for the purpose of protecting the separation membrane or the like. The outer-cladding material 3 is a member formed by coating the outside of the separation membrane using a glass fiber reinforced plastic (FRP) or a silicone resin. The end member is a member that is made of resin, metal or the like and protects the end surfaces of the separation membrane.

In the wound body 2, two end portions 2a, 2b in the axial direction of the fluid collecting tube 10 are bonded to the fluid collecting tube 10 at fixing portions 4. As an adhesive agent used in these fixing portions 4, any of conventionally known adhesives such as a urethane-based adhesive, an epoxy-based adhesive, a silicone-based adhesive, and a hot-melt adhesive can be used. However, in order to carry out a curing reaction by heating, an adhesive agent containing a thermosetting resin such as a urethane-based adhesive, an epoxy-based adhesive, or a silicone-based adhesive is preferable.

When the spiral-type separation membrane element shown in FIG. 3A is operated in a high-temperature environment, the whole element expands uniformly because the distance between the two fluid collecting tube main bodies 101, 102 becomes long due to the expansion of the wound body 2 or the outer-cladding material 3, as shown in FIG. 3B. Also, when the operation in the high-temperature environment is stopped, the whole element contracts uniformly because the distance between the two fluid collecting tube main bodies 101, 102 becomes short due to the contraction of the wound body 2 or the outer-cladding material 3, as shown in FIG. 3C. By this, the stress applied to the fixing portions 4 is reduced, and deformation due to receiving a thermal history for a long period of time can be prevented, so that the separation membrane element can be used for a long period of time even in a high-temperature environment.

### Other Embodiments

As shown above, one embodiment of the present invention has been described; however, the present invention is not limited to the above-described embodiment alone. For example, in the above-described embodiment, as an example in which the fluid collecting tube includes a stretchable portion, a case in which the central part in the axial direction has the stretchable portion at one place has been described; however, it is sufficient that the stretchable portion is provided at at least one place between the fixing portions, so that the stretchable portion may be provided at two or more places.

Also, in the above-described embodiment, the separation membrane element of the present invention has been described by raising, as an example, a spiral-type separation membrane element; however, the separation membrane element of the present invention is not limited to a spiral-type separation membrane element and may be, for example, a pleated-type separation membrane element or the like such as disclosed in JP-A-9-94443.

1. A separation membrane element comprising a fluid collecting tube, a separation membrane, and fixing portions provided at at least two places and fixing between the fluid collecting tube and the separation membrane, wherein the separation membrane element has at least one stretchable portion in the fluid collecting tube between the fixing portions.

2. The separation membrane element according to claim 1, wherein the stretchable portion is an engagement structure.

3. The separation membrane element according to claim 1, wherein the fluid collecting tube has at least two fluid collecting tube main bodies separated from each other and the stretchable portion, wherein the stretchable portion is a movable portion that connects the fluid collecting tube main bodies with each other.

4. The separation membrane element according to claim 2, wherein the fluid collecting tube is constituted of at least two fluid collecting tube main bodies separated from each other and a tube joint, wherein the engagement structure is a structure in which the fluid collecting tube main bodies are engaged with the tube joint.

5. The separation membrane element according to claim 2, wherein the fluid collecting tube is an engagement structure in which the at least two fluid collecting tube main bodies separated from each other are engaged with each other.

6. The separation membrane element according to claim 3, wherein the movable portion is a bellows structure.

7. The separation membrane element according to claim 6, wherein the bellows structure is one in which a metal is molded to have a bellows structure.

8. The separation membrane element according to claim 3, wherein a stretchable material is used in the movable portion.

9. The separation membrane element according to claim 1, wherein the separation membrane element is a spiral-type separation membrane element in which a single one of or a plurality of the separation membrane, a feed side flow path material, and a permeate side flow path material are wound around the fluid collecting tube.

10. A fluid collecting tube for a separation membrane element, having a stretchable portion that is extendible and contractible in an axial direction in a part of the fluid collecting tube.
